(19) United States
(12) Patent Application Publication
(10) Pub. No.: US 2026/0333272 A1
(43) Pub. Date: Oct. 22, 2026

(54) RESERVATION OF SIDELINK POSITIONING REFERENCE SIGNAL RESOURCES FOR USER EQUIPMENT

(71) Applicant: Nokia Technologies Oy, Espoo (FI)

(72) Inventors: Ryan KEATING, Chicago, IL (US); Hyun-Su CHA, Chicago, IL (US); Yong LIU, Shanghai (CN); Torsten WILDSCHEK, Gloucester (GB); Taylan SAHIN, Munich (DE); Prajwal KESHAVAMURTHY, Munich (DE); Anastasios KAKKAVAS, Munich (DE)

(73) Assignee: Nokia Technologies Oy, Espoo (FI)

(21) Appl. No.: 19/483,697

(22) PCT Filed: May 12, 2023
(86) PCT No.: PCT/CN2023/093764

§ 371 Date: Nov. 12, 2025

(51) Int. Cl. H04W 60/00; H04W 72/25

(52) U.S. Cl. CPC H04W 60/00; H04W 72/25

(57) ABSTRACT

Systems, methods, apparatuses, and computer program products for reservation of sidelink (SL) positioning reference signal (PRS) resources for user equipment (UEs). A method may include determining to reserve, for a user equipment, at least one resource for a sidelink positioning transmission from the user equipment. The method may also include transmitting sidelink control information, to the user equipment, including information of the at least one resource reservation for the user equipment. The method may further include receiving a feedback message, from the user equipment, indicating whether the at least one resource reservation is accepted or rejected.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for reservation of sidelink (SL) positioning reference signal (PRS) resources for user equipment (UEs).

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, fifth generation (5G) radio access technology or NR access technology, and/or 5G-Advanced. 5G wireless systems refer to the next generation (NG) of radio systems and network architecture. 5G network technology is mostly based on NR technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include determining to reserve, for a user equipment, at least one resource for a sidelink positioning transmission from the user equipment. The method may also include transmitting sidelink control information, to the user equipment, including information of the at least one resource reservation for the user equipment. The method may further include receiving a feedback message, from the user equipment, indicating whether the at least one resource reservation is accepted or rejected.

Other example embodiments may be directed to an apparatus. The apparatus may include at least one processor and at least one memory including computer program code. The at least one memory and the computer program code may be configured to, with storing instructions that, when executed by the at least one processor, cause the apparatus at least to determine to reserve, for a user equipment, at least one resource for a sidelink positioning transmission from the user equipment. The apparatus may also be caused to transmit sidelink control information, to the user equipment, including information of the at least one resource reservation for the user equipment. The apparatus may further be caused to receive a feedback message, from the user equipment, indicating whether the at least one resource reservation is accepted or rejected.

Other example embodiments may be directed to an apparatus. The apparatus may include means for determining to reserve, for a user equipment, at least one resource for a sidelink positioning transmission from the user equipment. The apparatus may also include means for transmitting sidelink control information, to the user equipment, including information of the at least one resource reservation for the user equipment. The apparatus may further include means for receiving a feedback message, from the user equipment, indicating whether the at least one resource reservation is accepted or rejected.

In accordance with other example embodiments, a non-transitory computer readable medium may be encoded with instructions that may, when executed in hardware, perform a method. The method may include determining to reserve, for a user equipment, at least one resource for a sidelink positioning transmission from the user equipment. The method may also include transmitting sidelink control information, to the user equipment, including information of the at least one resource reservation for the user equipment. The method may further include receiving a feedback message, from the user equipment, indicating whether the at least one resource reservation is accepted or rejected.

Other example embodiments may be directed to a computer program product that performs a method. The method may include determining to reserve, for a user equipment, at least one resource for a sidelink positioning transmission from the user equipment. The method may also include transmitting sidelink control information, to the user equipment, including information of the at least one resource reservation for the user equipment. The method may further include receiving a feedback message, from the user equipment, indicating whether the at least one resource reservation is accepted or rejected.

Other example embodiments may be directed to an apparatus that may include circuitry configured to determine to reserve, for a user equipment, at least one resource for a sidelink positioning transmission from the user equipment. The apparatus may also include circuitry configured to transmit sidelink control information, to the user equipment, including information of the at least one resource reservation for the user equipment. The apparatus may further include circuitry configured to receive a feedback message, from the user equipment, indicating whether the at least one resource reservation is accepted or rejected.

Some example embodiments may be directed to a method. The method may include receiving, from a first user equipment, sidelink control information including information of at least one resource reserved for a second user equipment. The method may also include determining whether to accept or reject the at least one resource for a sidelink positioning transmission. The method may further include transmitting a feedback message to the first user equipment in response to the sidelink control information.

Other example embodiments may be directed to an apparatus. The apparatus may include at least one processor and at least one memory including computer program code. The at least one memory and the computer program code may be configured to, with storing instructions that, when executed by the at least one processor, cause the apparatus at least to receive, from a user equipment, sidelink control information including information of at least one resource reserved for the apparatus. The apparatus may also be caused to determine whether to accept or reject the at least one resource for a sidelink positioning transmission. The apparatus may further be caused to transmit a feedback message to the user equipment in response to the sidelink control information.

Other example embodiments may be directed to an apparatus. The apparatus may include means for receiving, from a user equipment, sidelink control information including information of at least one resource reserved for the apparatus. The apparatus may also include means for determining whether to accept or reject the at least one resource for a sidelink positioning transmission. The apparatus may further include means for transmitting a feedback message to the user equipment in response to the sidelink control information.

In accordance with other example embodiments, a non-transitory computer readable medium may be encoded with instructions that may, when executed in hardware, perform a method. The method may include receiving, from a first user equipment, sidelink control information including information of at least one resource reserved for a second user equipment. The method may also include determining whether to accept or reject the at least one resource for a sidelink positioning transmission. The method may further include transmitting a feedback message to the first user equipment in response to the sidelink control information.

Other example embodiments may be directed to a computer program product that performs a method. The method may include receiving, from a first user equipment, sidelink control information including information of at least one resource reserved for a second user equipment. The method may also include determining whether to accept or reject the at least one resource for a sidelink positioning transmission. The method may further include transmitting a feedback message to the first user equipment in response to the sidelink control information.

Other example embodiments may be directed to an apparatus that may include circuitry configured to receive, from a user equipment, sidelink control information including information of at least one resource reserved for the apparatus. The apparatus may also include circuitry configured to determine whether to accept or reject the at least one resource for a sidelink positioning transmission. The apparatus may further include circuitry configured to transmit a feedback message to the user equipment in response to the sidelink control information.

### BRIEF DESCRIPTION OF THE DRAWINGS:

For proper understanding of example embodiments, reference should be made to the accompanying drawings, wherein:

FIG. 1 illustrates an example sidelink (SL) round trip time (RTT) positioning scenario.

FIG. 2 illustrates an example signal flow diagram, according to certain example embodiments.

FIG. 3 illustrates an example of another signal flow diagram, according to certain example embodiments.

FIG. 4 illustrates an example flow diagram of a method, according to certain example embodiments.

FIG. 5 illustrates an example flow diagram of another method, according to certain example embodiments.

FIG. 6 illustrates a set of apparatuses, according to certain example embodiments.

### DETAILED DESCRIPTION:

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for reservation of sidelink (SL) positioning reference signal (PRS) resources for user equipment (UEs).

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

The technical specifications of the Third Generation Partnership Project (3GPP) New Radio (NR) describe SL positioning, and specify solutions for support of SL positioning (including ranging) in NR systems. Additionally, SL PRS may be supported in both shared and dedicated resource pools, where the shared resource pools mean that the SL data communication can also occur in the same resource pool as SL PRS and dedicated means the resource pool is only for SL positioning.

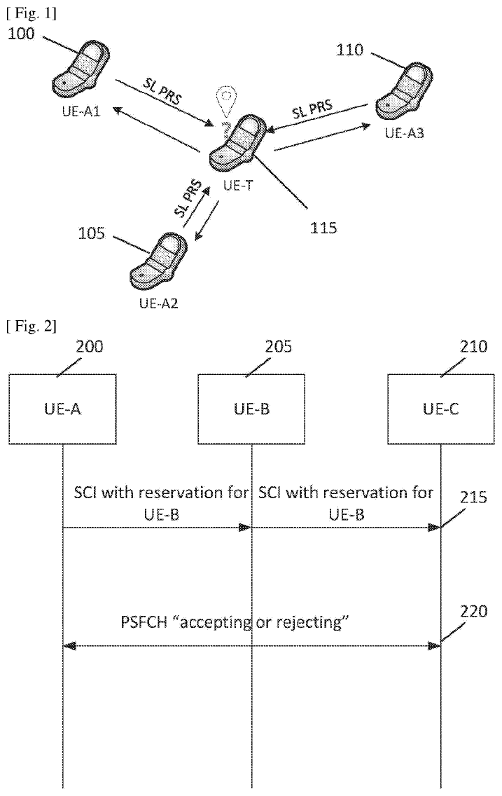

FIG. 1 illustrates an example SL round trip time (RTT) positioning scenario. In particular, FIG. 1 illustrates a SL-RTT positioning scenario where a target UE 115 (UE-T) is performing SL positioning by receiving SL PRS from three anchor UEs 100, 105, 110 (UE-A1, UE-A2, and UE-A3). The scenario illustrated in FIG. 1 includes a target UE 115 (UE-T), and anchor UEs 100, 105, 110 (UE-A1, UE-A2, and UE-A3). SL positioning may be based on transmissions of SL PRS by one or more anchor UEs 100, 105, 110 to be received by a target UE 115 in, for example, SL time difference of arrival (TDOA) methods, or SL PRS exchange between the anchor(s) and the target UEs. The SL PRS exchange between the anchor(s) and the target UEs may be in, for example a SL (multi-) RTT method to enable localization of the target UE 115 and/or ranging of the target UE 115 with respect to a reference UE (e.g., anchor UE 100, 105, 110) within precise latency and accuracy requirements of the corresponding SL positioning.

In the SL positioning scenario illustrated in FIG. 1, the target UE 115 (UE-T) is performing SL positioning by receiving SL PRS from three anchor UEs 100, 105, 110 (UE-A1, UE-A2, and UE-A3). The target UE 115 may also determine its location by using an SL TDOA method. Thus, in the example of FIG. 1, the anchor UEs 100, 105, 110 may provide SL PRS assistance (including SL PRS) to the target UE 115.

As illustrated in FIG. 1, the target UE 115 may correspond to the UE to be positioned (using SL, i.e., PC5 interface), and the anchor UEs 100, 105, 110 may be UEs supporting positioning of the target UE 115 (e.g., by transmitting and/or receiving reference signals for positioning, providing positioning-related information, etc.) over the SL interface. As illustrated in FIG. 1, SL positioning may refer to the positioning UE using reference signals transmitted over SL (i.e., PC5 interface) to obtain an absolute position, relative position, or ranging information. Ranging may correspond to determining the distance and/or the direction between a UE and another entity (e.g., anchor UE). As further illustrated in FIG. 1, the SL PRS may refer to a reference signal transmitted over SL for positioning purposes. Additionally, the SL PRS (pre-) configuration may correspond to parameters of SL PRS such as time-frequency resources (other parameters are not precluded) including its bandwidth and periodicity.

In SL positioning, the SL PRS may be transmitted and received by UEs involved in the SL positioning session. A SL PRS resource is a collection of symbols that make up the SL PRS transmission. In addition, a SL PRS resource may include a collection of resource block(s) and sequence(s).

SL positioning may be based on the transmissions of SL PRS by multiple anchor UEs to be received by a target UE in, for example, SL time difference of arrival (TDOA) methods, or SL PRS exchange between the anchor(s) and the target UEs in, for example, an SL (multi-) RTT method. The (multi-) RTT method may enable localization of the target UE and/or ranging of the target UE with respect to a reference UE (e.g., anchor UE) within precise latency and accuracy requirements of the corresponding SL positioning.

In SL communications resource selection mode 2 (UE autonomous resource selection), a UE may autonomously select resources to reserve and then transmit on the reserved resources when it requires them. In some cases, the UE may be enabled to schedule (or reserve) resources for another UE, which can be a use case for SL positioning since one UE scheduling (or reserving) resources for another UE may be valuable (e.g., RTT) as latency can be important.

In SL-RTT, both UEs, anchor UE and target UE, may need to transmit SL PRS.

Having the shortest time possible between the transmissions of the anchor UE and the target UE may be important to positioning accuracy and latency. For instance, if the time between the transmission is too long, the UEs may have moved and/or the clock drift and/or potential change of synchronization reference may become an issue to guarantee accurate measurements.

If one UE (e.g., target UE) is able to schedule or reserve the time frequency resources for the other UE (e.g., anchor UE) to transmit SL PRS, then the overall latency of the process may be reduced. In this case, the other UE may choose not to use the scheduled resource (e.g., due to prioritizing uplink (UL) transmissions or SL transmissions). If the other UE chooses not to use the scheduled resource, the scheduled resource may be wasted. Thus, to address this issue, certain example embodiments may provide ways to efficiently enable one UE to schedule or reserve one or more resources for another UE to transmit SL PRS.

In view of the drawbacks described above, certain example embodiments may utilize a handshaking procedure between multiple UEs (e.g., UE-A, UE-B, and UE-C).

Although certain example embodiments described herein refer to UEs A-C, additional UEs may also be applicable in other example embodiments. In certain example embodiments, the handshaking procedure may reserve/schedule resources for UE-B to use for transmitting SL PRS and for UE-B to accept or reject the reservation. As such, certain example embodiments may utilize the reception/transmission of a feedback of “accept”/“ reject” from UE-B on whether or not UE-B intends to use the resources reserved by UE-A for UE-B.

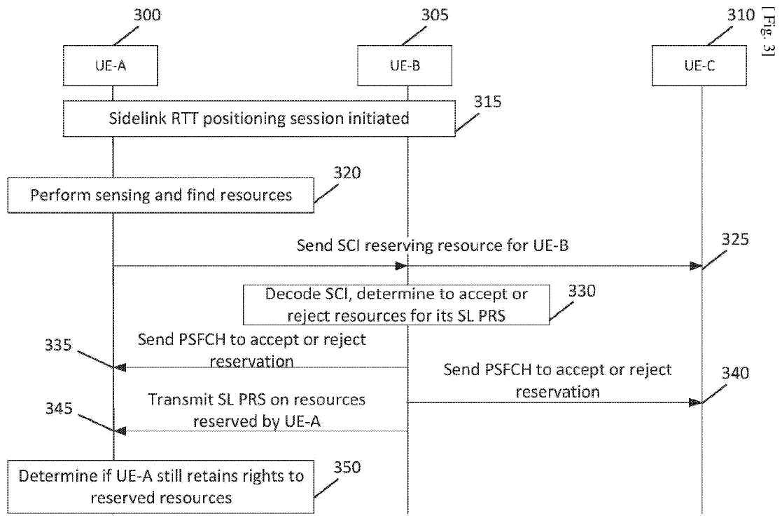

According to certain example embodiments, the feedback may be received by UE-A and neighboring UEs such as, for example, UE-C as illustrated in FIG. 2. With this feedback, UE-C can determine whether or not UE-B intends to use the resource reserved by UE-A for UE-B. If UE-B rejects the resource, even though a resource may be reserved by UE-A for UE-B, UE-C may still consider that resource as a candidate resource in its own resource selection.

FIG. 2 illustrates an example signal flow diagram, according to certain example embodiments. As noted above, the signal flow diagram may be between UE-A 200, UE-B 205, and UE-C 210. However, in other example embodiments, there may be more UEs than that illustrated in FIG. 2. As described herein certain example embodiments may be for SL-RTT procedures where UE-A 200 transmits SL PRS to UE-B 205, and then UE-B 205 may need to send its own SL PRS back to UE-A 200. As illustrated in FIG. 2, at 215, UE-A 200 may use sidelink control information (SCI) to reserve resources for UE-B 205 to transmit SL PRS on. At 220, UE-B 205 may then use the physical sidelink feedback channel (PSFCH) to inform both UE-A 200 and other UEs (UE-C 210) if the reservation made by UE-A 200 is accepted or rejected.

FIG. 3 illustrates an example of another signal flow diagram, according to certain example embodiments. As discussed in more detail below, certain example embodiments may allow for UE-A to reserve resources for UE-B to transmit SL PRS on, and for UE-B to accept or deny the reservation of resources. FIG. 3 illustrates both cases of where UE-B accepts and rejects the reservation, where only one of operations 345 or 350 is performed at a time. Additionally, as illustrated in FIG. 3, UE-A 300 and UE-B 305 may both be anchor UEs or target UEs in different scenarios. Although an example of SL-RTT is illustrated in FIG. 3 as an example, other SL positioning techniques may also be applied in other example embodiments.

As illustrated in FIG. 3, at 315, an SL-RTT positioning session is initiated between UE-A 300 and UE-B 305, where both UE-A 300 and UE-B 305 need to transmit SL PRS to each other. At 320, UE-A performs sensing and find resources (e.g., in a resource pool) suitable for its own SL PRS transmission, and resources suitable for UE-B's 305 SL PRS transmission. In some example embodiments, when UE-A performs sensing, it may determine which time frequency resources may be available by first determining, from SCI decoding, if any resources have already been reserved. UE-A may then use SL measurements to determine which resources may be available. At 325, UE-A 300 transmits SCI to UE-B 305 and UE-C 310 to reserve resources for UE-A 300 and UE-B's 305 SL PRS. Thus, the SCI is received by both UE-B 305 and other UEs such as, for example UE-C 310, and UE-C 310 may know of the reserved resources for UE-A 300 and UE-B 305.

According to certain example embodiments, UE-A 300 may use a first stage SCI to reserve the resource so that legacy UEs are able to decode the SCI and know that resources are reserved. According to other example embodiments, UE-A 300 may transmit one first stage SCI with multiple resources reserved, and then indicate in a second stage SCI which resources correspond to UE-A's transmission and which resources correspond to UE-B's transmission. In some example embodiments, UE-A 300 may indicate at least two resources, one (or more) of which may be selected by UE-B 305 for its transmission. Additionally, UE-A 300 may reserve multiple resources for UE-B 305. The reservation of multiple resources for UE-B 305 may be useful for a double-sided RTT method where multiple SL PRS transmissions may be expected from a UE.

At 330, UE-B 305 decodes the SCI received from UE-A 300, and determines that there are resources reserved for UE-B 305 by UE-A 300. UE-B 305 may also determine whether it will accept or reject the reservation. In certain example embodiments, UE-B 305 may determine, for example, that there is a conflict in the resources (e.g., conflict with another SCI received from another UE, such as UE-C 310), that UE-B 305 has data it wishes to send/receive during the time slot of the reserved resources, or that UE-B 305 has a higher priority Uu transmission in the same slot as the reserved resources. According to certain example embodiments, if multiple resources were indicated by UE-A 300, then UE-B 305 may determine if one or more of those resources will be used.

At 335, UE-B 305 transmits PSFCH to UE-A 300, and at 340, UE-B 305 transmits PSFCH to UE-C 310 to inform UE-A 300 and UE-C 310 if it has accepted or rejected the reservation from UE-A 300. In certain example embodiments, other UEs (e.g., UE-C 310 or other UEs not shown in FIG. 3) may also decode the PSFCH to understand if UE-B 305 will accept or reject the reservation, and update their sensing procedures accordingly.

According to certain example embodiments, feedback messages (i.e., operations 335 and 340) may be transmitted by UE-B 305 in PSFCH resource that is associated with the physical sidelink control channel (PSCCH) resource in which the SCI was sent by UE-A 300. That is, there may be a mapping between PSSCH and PSFCH resources. Using this mapping, UE-A 300 may monitor associated PSFCH resource for feedback. In one example, the operations 335 and 340 may be performed at the same time by UE-B, broadcasting or multi-casting PSFCH to indicate accepting or rejecting the reserved resource for its SL PRS by UE-A. Additionally, neighboring UEs, for example, UE-C 310 being the one or the one of them, may also identify and monitor the PSFCH resource to become aware of whether UE-B 305 has accepted or rejected the resource that is reserved by UE-A 300 for UE-B 305.

In certain example embodiments, UE-B 305 may send an SCI that will re-reserve the resources already reserved by UE-A 300 for UE-B 305. In doing so, it may be possible to resolve potential hidden node problems. A hidden node problem may be present when one UE (e.g., UE-A) reserves a resource and informs a second UE (e.g., UE-B). However, a third UE (e.g., UE-C) which UE-B can hear, cannot be heard by UE-A. Thus, UE-C becomes a hidden node from UE-A's perspective, and UE-C could potentially reserve the same resources as UE-A (as it cannot hear UE-A), which results in a conflict. As one example embodiment, the SCI transmitted by UE-B 305 may replace the need for UE-B 305 to transmit PSFCH to UE-A 300 and other UEs (e.g., UE-C 310). In another example embodiment, the SCI transmitted by UE-B 305 may be transmitted in addition to sending the PSFCH to UE-A 300. In further example embodiments, there may be a timer by which UE-B 305 must transmit SCI to accept the reserved resources. If the SCI is not transmitted within the time set by the timer, then the resources are not accepted by default. In certain example embodiments, the timer may be preconfigured or configured as part of the initial SCI.

According to certain example embodiments, UE-B 305 may partially accept the resources reserved by SCI from UE-A 300. For example, UE-B 305 may indicate that it will accept the resources but with a different comb size. According to other example embodiments, UE-B 305 may indicate a subset of the resources from the available choices (e.g., available resources) provided by UE-A 300 to accept for its SL PRS transmission. According to further example embodiments, when there are multiple SL PRS resources reserved by UE-A 300 for UE-B 305, UE-B 305 may use different sequences such as different ZC (Zadoff-Chu) sequences to convey to UE-A 300 which of the reserved resources are acceptable at UE-B 305. For example, when resource-1 and resource-2 are reserved by UE-A 300 for UE-B 305, UE-B 305 may transmit PSFCH sequence-1 and/or sequence-2 to convey acceptance of resource-1 and/or resource-2. For example, the PSFCH sequence-1 and sequence-2 may be two ZC sequences generated based on the same root index with different cyclic shift, or they may be two ZC sequences generated based on the different root indexes.

As further illustrated in FIG. 3, at 345, if UE-B 305 accepts the reservation, it may transmit SL PRS on the resources initially reserved by UE-A 300 for UE-B 305. However, if UE-B 305 rejects the reservation, then, at 350, UE-A may determine if UE-A 300 should retain the rights (i.e., keep) to those reserved resources, and use them for its own transmissions (e.g., of PSSCH, or of SL PRS). Alternatively, in other example embodiments, if UE-B 305 rejects the reservation, those resources may be unreserved. When the resources are unreserved, if UE-A 300 or any other UE wants to use those resources, UE-A 300 or the other UEs may need to transmit a new SCI to reserve them.

In certain example embodiments, the network (e.g., gNB or location management function (LMF)) may (pre)-configure the behavior illustrated in FIG. 3 to determine if in a given resource pool, UEs can schedule/reserve SL PRS for other UEs. For example, using radio resource control (RRC), the network may indicate when the UE is (pre)-configured that a resource pool allows for UEs to reserve resources for other UEs to transmit SL PRS.

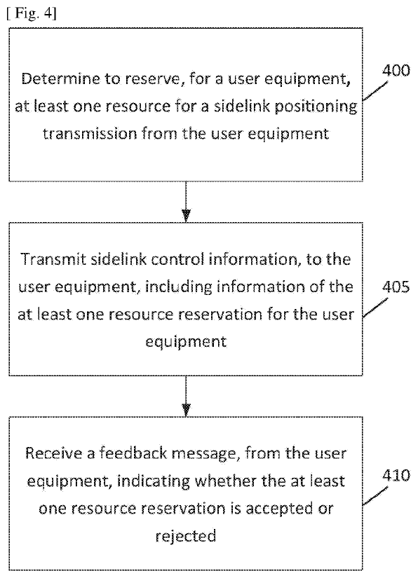

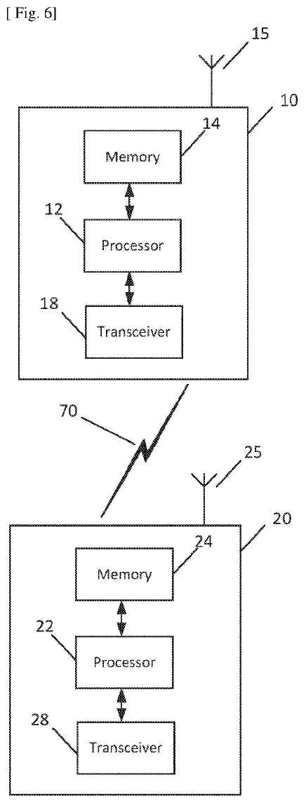

FIG. 4 illustrates an example flow diagram of a method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by UE-A similar to one of apparatuses 10 or 20 illustrated in FIG. 6.

According to certain example embodiments, the method of FIG. 4 may include, at 400, determining to reserve, for a UE, at least one resource for a SL positioning transmission from the UE. The method may also include, at 405, transmitting SCI, to the user equipment, including information of the at least one resource reservation for the UE. The method may further include, at 410, receiving a feedback message, from the UE, indicating whether the at least one resource reservation is accepted or rejected.

According to certain example embodiments, the method may further include, based on the feedback message, receiving, from the UE, the SL positioning transmission on the at least one resource, or determining whether to keep the at least one resource. According to some example embodiments, the at least one resource may include at least one of a set of at least one symbol index, a slot index, or a resource block index within a sidelink bandwidth part. According to other example embodiments, when the feedback message indicates that the at least one resource reservation is accepted, the SL positioning transmission is received. In some example embodiments, “when the feedback message indicates that . . . ” may be understood as “in response to the at least one resource is accepted”. Additionally, the feedback message and the SL positioning transmission do not need to be transmitted at the same time.

In certain example embodiments, the SL positioning transmission may be received on the at least one resource when the at least one resource is accepted at the UE. As similarly noted above, in some example embodiments, “when the at least one resource is accepted” may be understood as “in response to the SL positioning transmission being received on the at least one resource”. That is, in some example embodiments, the acceptance of the at least one resource and the receipt of the SL positioning transmission do not need to occur at the same time. In some example embodiments, the determination of whether to keep the at least one resource may be performed in response to receiving rejection to the at least one resource from the UE. In other example embodiments, in response to receiving rejection to the at least one resource, the method may further include determining not to keep the at least one resource. In further example embodiments, the SCI may be a first stage SCI or a second stage SCI.

According to certain example embodiments, the first stage SCI may include a plurality of resources. According to some example embodiments, the second stage SCI may include an indication of which of the at least one resource corresponds to another UE's transmission, and which of the at least one resource corresponds to the UE's transmission. According to other example embodiments, the sidelink control information is transmitted to the UE via a PSCCH resource. According to further example embodiments, the feedback message may be received via a PSFCH resource. According to other example embodiments, the PSFCH may be associated with the PSCCH.

In certain example embodiments, the acceptance of the at least one resource reservation may be a partial acceptance of the at least one resource. In some example embodiments, the acceptance the at least one resource reservation may indicate a subset of resources of the at least one resource. In other example embodiments, the partial acceptance may include using the subset of resources for the SL positioning transmission.

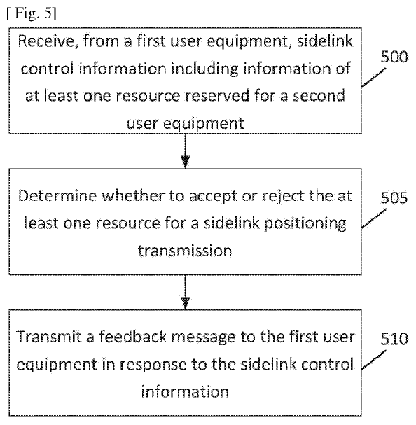

FIG. 5 illustrates an example flow diagram of another method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by UE-B similar to one of apparatuses 10 or 20 illustrated in FIG. 6.

According to certain example embodiments, the method of FIG. 5 may include, at 500, receiving, from a first UE, SCI including information of at least one resource reserved for a second UE. The method may also include, at 505, determining whether to accept or reject the at least one resource for a SL positioning transmission. The method may further include, at 510, transmitting a feedback message to the first UE in response to the sidelink control information.

According to certain example embodiments, the feedback message may indicate that the at least one resource reservation is accepted, or rejected. According to some example embodiments, the at least one resource comprises at least one of a set of at least one symbol index, a slot index, or a resource block index within a SL BWP. According to other example embodiments, the SL positioning transmission may include a SL positioning reference signal on the at least one resource reserved at the first UE. According to further example embodiments, when the feedback message includes the indication of rejection, the at least one resource becomes unreserved. In some example embodiments, “unreserved” may also be called “released”.

In certain example embodiments, the SCI may be a first stage SCI or a second stage SCI. In some example embodiments, the first stage SCI may include a plurality of resources. In other example embodiments, the second stage SCI may include an indication of which of the at least one resource corresponds to the second UE's transmission, and which of the at least one resource corresponds to the first UE's transmission. In further example embodiments, the SCI may be received via a PSCCH. In other example embodiments, the feedback message may be transmitted via a PSFCH. In other example embodiments, the PSFCH resource may be associated with the PSCCH.

According to certain example embodiments, the indication of acceptance may be a partial acceptance of the at least one resource. According to some example embodiments, the indication of acceptance may indicate an acceptance of a subset of resources of the at least one resource. According to other example embodiments, the method may further include transmitting a SCI that re-reserves the at least one resource that has been reserved.

FIG. 6 illustrates a set of apparatuses 10 and 20 according to certain example embodiments. In certain example embodiments, apparatuses 10 and 20 may be elements in a communications network or associated with such a network. For example, apparatus 10 may be a UE, and apparatus 20 may be a network (i.e., gNB).

In some example embodiments, apparatuses 10 and 20 may include one or more processors, one or more computer-readable storage medium (for example, memory, storage, or the like), one or more radio access components (for example, a modem, a transceiver, or the like), and/or a user interface. In some example embodiments, apparatuses 10 and 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatuses 10 and 20 may include components or features not shown in FIG. 6.

As illustrated in the example of FIG. 6, apparatuses 10 and 20 may include or be coupled to a processors 12 and 22 for processing information and executing instructions or operations. Processors 12 and 22 may be any type of general or specific purpose processor. In fact, processors 12 and 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processors 12 and 22 is shown in FIG. 6, multiple processors may be utilized according to other example embodiments. For example, it should be understood that, in certain example embodiments, apparatuses 10 and 20 may include two or more processors that may form a multiprocessor system (e.g., in this case processors 12 may represent a multiprocessor) that may support multiprocessing. According to certain example embodiments, the multiprocessor system may be tightly coupled or loosely coupled (e.g., to form a computer cluster).

Processors 12 and 22 may perform functions associated with the operation of apparatuses 10 and 20 including, as some examples, precoding of antenna gain/phase parameters, encoding and decoding of individual bits forming a communication message, formatting of information, and overall control of the apparatuses 10 and 20, including processes and examples illustrated in FIGS. 1-5.

Apparatuses 10 and 20 may further include or be coupled to a memories 14 and 24 (internal or external), which may be respectively coupled to processors 12 and 24 for storing information and instructions that may be executed by processors 12 and 24. Memories 14 and 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memories 14 and 24 can be comprised of any combination of random access memory (RAM), read only memory (ROM), static storage such as a magnetic or optical disk, hard disk drive (HDD), or any other type of non-transitory machine or computer readable media. The instructions stored in memories 14 and 24 may include program instructions or computer program code that, when executed by processors 12 and 22, enable the apparatuses 10 and 20 to perform tasks as described herein.

In certain example embodiments, apparatuses 10 and 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 12 and 22 and/or apparatuses 10 and 20 to perform any of the methods and examples illustrated in FIGS. 1-5.

In some example embodiments, apparatuses 10 and 20 may also include or be coupled to one or more antennas 15 and 25 for receiving a downlink signal and for transmitting via an UL from apparatuses 10 and 20. Apparatuses 10 and 20 may further include a transceivers 18 and 28 configured to transmit and receive information. The transceivers 18 and 28 may also include a radio interface (e.g., a modem) coupled to the antennas 15 and 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceivers 18 and 28 may be configured to modulate information on to a carrier waveform for transmission by the antennas 15 and 25 and demodulate information received via the antenna 15 and 25 for further processing by other elements of apparatuses 10 and 20. In other example embodiments, transceivers 18 and 28 may be capable of transmitting and receiving signals or data directly. Additionally or alternatively, in some example embodiments, apparatus 10 may include an input and/or output device (I/O device). In certain example embodiments, apparatuses 10 and 20 may further include a user interface, such as a graphical user interface or touchscreen.

In certain example embodiments, memories 14 and 34 store software modules that provide functionality when executed by processors 12 and 22. The modules may include, for example, an operating system that provides operating system functionality for apparatuses 10 and 20. The memory may also store one or more functional modules, such as an application or program, to provide additional functionality for apparatuses 10 and 20. The components of apparatuses 10 and 20 may be implemented in hardware, or as any suitable combination of hardware and software. According to certain example embodiments, apparatuses 10 and 20 may optionally be configured to communicate each other (in any combination) via a wireless or wired communication links 70 according to any radio access technology, such as NR.

According to certain example embodiments, processors 12 and 22 and memories 14 and 24 may be included in or may form a part of processing circuitry or control circuitry. In addition, in some example embodiments, transceivers 18 and 28 may be included in or may form a part of transceiving circuitry.

For instance, in certain example embodiments, apparatus 10 may be controlled by memory 14 and processor 12 to determine to reserve, for a UE, at least one resource for a SL positioning transmission from the UE. Apparatus 10 may also be controlled by memory 14 and processor 12 to transmit SCI, to the user equipment, including information of the at least one resource reservation for the UE. Apparatus 10 may further be controlled by memory 14 and processor 12 to receive a feedback message, from the UE, indicating whether the at least one resource reservation is accepted or rejected.

In other example embodiments, apparatus 20 may be controlled by memory 24 and processor 22 to receive, from a user equipment, sidelink control information including information of at least one resource reserved for the apparatus. Apparatus 20 may also be controlled by memory 24 and processor 22 to determine whether to accept or reject the at least one resource for a SL positioning transmission, Apparatus 20 may further be controlled by memory 24 and processor 22 to transmit a feedback message to the UE in response to the SCI.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for determining to reserve, for a UE, at least one resource for a SL positioning transmission from the UE. The apparatus may also include means for transmitting SCI, to the UE, including information of the at least one resource reservation for the UE.

The apparatus may further include means for receiving a feedback message, from the UE, indicating whether the at least one resource reservation is accepted or rejected.

According to certain example embodiments, the apparatus may also include, based on the feedback message, means for receiving, from the UE, the SL positioning transmission on the at least one resource, or means for determining whether to keep the at least one resource. According to some example embodiments, the at least one resource comprises at least one of a set of at least one symbol index, a slot index, or a resource block index within a sidelink bandwidth part. According to other example embodiments, when the feedback message indicates that the at least one resource reservation is accepted, the SL positioning transmission may be received. According to further example embodiments, the SL positioning transmission may be received on the at least one resource when the at least one resource is accepted at the UE.

In certain example embodiments, the determination of whether to keep the at least one resource may be performed in response to receiving rejection to the at least one resource from the UE. In some example embodiments, in response to receiving rejection to the at least one resource, the apparatus may further include means for determining not to keep the at least one resource. In other example embodiments, the SCI is a first stage SL control information or a second stage SL control information. In further example embodiments, the first stage SCI may include a plurality of resources.

According to certain example embodiments, the second stage SCI may include an indication of which of the at least one resource corresponds to another UE's transmission, and which of the at least one resource corresponds to the UE's transmission. According to some example embodiments, the SCI may be transmitted to the UE via a PSCCH resource. According to other example embodiments, the feedback message may be received via a PSFCH resource. According to further example embodiments, the PSFCH resource may be associated with the PSCCH resource.

In certain example embodiments, the acceptance of the at least one resource reservation may be a partial acceptance of the at least one resource. In some example embodiments, the acceptance of the at least one resource reservation may indicate a subset of resources of the at least one resource. In other example embodiments, the partial acceptance may include using the subset of resources for the SL positioning transmission.

Additional example embodiments may be directed to an apparatus that includes means for performing any of the methods described herein including, for example, means for receiving, from a UE, SCI including information of at least one resource reserved for the apparatus. The apparatus may also include means for determining whether to accept or reject the at least one resource for a SL positioning transmission. The apparatus may further include means for transmitting a feedback message to the UE in response to the SCI.

According to certain example embodiments, the feedback message may indicate that the at least one resource reservation is accepted, or rejected. According to some example embodiments, the at least one resource comprises at least one of a set of at least one symbol index, a slot index, or a resource block index within a SL BWP.

According to other example embodiments, the SL positioning transmission may include a SL positioning reference signal on the at least one resource reserved at the UE.

In certain example embodiments, when the feedback message includes the indication of rejection, the at least one resource becomes unreserved. In some example embodiments, the SCI may be a first stage SCI or a second stage SCI. In other example embodiments, the first stage SCI may include a plurality of resources. In further example embodiments, the second stage SCI may include an indication of which of the at least one resource corresponds to the apparatus' transmission, and which of the at least one resource corresponds to the UE's transmission.

According to certain example embodiments, the SCI may be received via a PSCCH resource, the feedback message may be transmitted via a PSFCH resource, and the PSFCH resource may be associated with the PSCCH resource. According to some example embodiments, the indication of acceptance may be a partial acceptance of the at least one resource. According to other example embodiments, the indication of acceptance may indicate an acceptance of a subset of resources of the at least one resource. According to further example embodiments, the apparatus may also include means for transmitting a sidelink control information that re-reserves the at least one resource that has been reserved.

Certain example embodiments described herein provide several technical improvements, enhancements, and/or advantages. For instance, in some example embodiments, it may be possible for other UEs to know the resources that are conditionally reserved by SCI from UE-A. In other example embodiments, it may be possible to reduce latency and improve positioning accuracy of target UEs.

Furthermore, as described herein, certain example embodiments may enable UEs to efficiently schedule or reserve resources for other UEs to transmit SL PRS. In addition, certain example embodiments may improve resource efficiency by reserving from a target UE only the required amount of resources to achieve a target accuracy.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s).

Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
5GCN 5G Core Network
5GS 5G System
AP Antenna Port
AS Antenna Switching
BS Base Station
DCI Downlink Control Information
DL Downlink
eNB Enhanced Node B
E-UTRAN Evolved UTRAN
gNB 5G or Next Generation NodeB
LMF Location Manage Function
LTE Long Term Evolution
NR New Radio
PRS Positioning Reference Signal
PSCCH Physical Sidelink Control Channel
PSFCH Physical Sidelink Feedback Channel
PSSCH Physical Sidelink Shared Channel
RRC Radio Resource Control
RTT Round Trip Time
SCI Sidelink Control Information
SL Sidelink
SRS Sounding Reference Signal
UE User Equipment
UL Uplink

1-26. (canceled)

27. An apparatus, comprising:
at least one processor; and
at least one memory comprising computer program code,
the at least one memory and the computer program code configured to, with storing instructions that, when executed by the at least one processor, cause the apparatus at least to:
determine to reserve, for a user equipment, at least one resource for a sidelink positioning transmission from the user equipment;
transmit sidelink control information, to the user equipment, including information of the at least one resource reservation for the user equipment; and
receive a feedback message, from the user equipment, indicating whether the at least one resource reservation is accepted or rejected.

28. The apparatus according to claim 27, wherein the apparatus is further caused to:
based on the feedback message,
receive, from the user equipment, the sidelink positioning transmission on the at least one resource, or
determine whether to keep the at least one resource.

29. The apparatus according to claim 27-or claim 28, wherein the at least one resource comprises at least one of the following:
a set of at least one symbol index,
a slot index, or
a resource block index within a sidelink bandwidth part.

30. The apparatus according to claim 27, wherein when the feedback message indicates that the at least one resource reservation is accepted, the sidelink positioning transmission is received.

31. The apparatus according to claim 27, wherein the sidelink positioning transmission is received on the at least one resource when the at least one resource is accepted at the user equipment.

32. The apparatus according to claim 28, wherein the determination of whether to keep the at least one resource is performed in response to receiving rejection to the at least one resource from the user equipment.

33. The apparatus according to claim 32, wherein in response to receiving rejection to the at least one resource, the apparatus is further caused to determine not to keep the at least one resource.

34. The apparatus according to claim 27, wherein the sidelink control information is a first stage sidelink control information or a second stage sidelink control information.

35. The apparatus according to claim 34, wherein the first stage sidelink control information comprises a plurality of resources.

36. The apparatus according to claim 34, wherein the second stage sidelink control information comprises an indication of which of the at least one resource corresponds to another user equipment's transmission, and which of the at least one resource corresponds to the user equipment's transmission.

37. The apparatus according to claim 27,
wherein the sidelink control information is transmitted to the user equipment via a physical sidelink control channel resource,
wherein the feedback message is received via a physical sidelink feedback channel resource, and
wherein the physical sidelink feedback channel resource is associated with the physical sidelink control channel resource.

38. The apparatus according to claim 27, wherein the acceptance of the at least one resource reservation is a partial acceptance of the at least one resource.

39. The apparatus according to claim 27, wherein the acceptance of the at least one resource reservation indicates a subset of resources of the at least one resource.

40. The apparatus according to claim 39, wherein the partial acceptance comprises using the subset of resources for the sidelink positioning transmission.

41. An apparatus, comprising:
at least one processor; and
at least one memory comprising computer program code,
the at least one memory and the computer program code configured to, with storing instructions that, when executed by the at least one processor, cause the apparatus at least to:
receive, from a user equipment, sidelink control information including information of at least one resource reserved for the apparatus;
determine whether to accept or reject the at least one resource for a sidelink positioning transmission; and
transmit a feedback message to the user equipment in response to the sidelink control information.

42. The apparatus according to claim 41, wherein the feedback message indicates that the at least one resource reservation is accepted, or rejected.

43-45. (canceled)

46. The apparatus according to claim 41, wherein the sidelink control information is a first stage sidelink control information or a second stage sidelink control information.

47-48. (canceled)

49. The apparatus according to claim 41,
wherein the sidelink control information is received via a physical sidelink control channel resource,
wherein the feedback message is transmitted via a physical sidelink feedback channel resource, and
wherein the physical sidelink feedback channel resource is associated with the physical sidelink control channel resource.

50. The apparatus according to claim 41, wherein the indication of acceptance is a partial acceptance of the at least one resource.

51-56. (canceled)

57. A method, comprising:
determining to reserve, for a user equipment, at least one resource for a sidelink positioning transmission from the user equipment;
transmitting sidelink control information, to the user equipment, including information of the at least one resource reservation for the user equipment; and
receiving a feedback message, from the user equipment, indicating whether the at least one resource reservation is accepted or rejected.
